(19) United States
(12) Patent Application Publication
(10) Pub. No.: US 2012/0030686 A1
(43) Pub. Date: Feb. 2, 2012

(54) THERMAL LOAD MANAGEMENT IN A PARTITIONED VIRTUAL COMPUTER SYSTEM ENVIRONMENT THROUGH MONITORING OF AMBIENT TEMPERATURES OF ENVIRNOMENT SURROUNDING THE SYSTEMS

(75) Inventors: Maharaj Mukherjee, Hopewell Junction, NY (US); Paul John Landsberg, Durham, NC (US)

(73) Assignee: International Business Machines Corporation, Armonk, NY (US)

(21) Appl. No.: 12/846,164

(22) Filed: Jul. 29, 2010

(51) Int. Cl. G06F 9/46

(52) U.S. Cl. 718/105

(57) ABSTRACT

Thermal load, management in a virtualized environment wherein server controlled physical processor systems are partitioned into a plurality of logical partitions LPARs that comprise first predetermining a set of ambient temperature levels for the surrounding outside environment for a first server controlled system having a plurality of LPARs. Then the ambient set of temperature levels are sensed and, if the set or predetermined pattern of temperature levels are exceeded, one or more of the plurality of LPARs are transferred from said first server controlled system to a second server controlled LPAR system over a connecting network.

### TECHNICAL FIELD

The present invention relates to a virtualized system environment that includes a plurality of virtual server controlled partitioned computer systems, and particularly to the monitoring of ambient temperatures in the environment of the facilities surrounding the computers.

### BACKGROUND OF RELATED ART

Over the past generation, virtualization of computer processors has become conventional. This virtualization involves time slicing of the virtual processors or machines between physical processors through partitioning. In such virtual processor environments, multiple users, i.e. client devices, are connected to each virtual processor platform that provides a plurality of physical processors respectively connected to these clients. The trend toward virtualization environments has created more concentrated physical processing environments, e.g. virtual environment data centers. Rising equipment temperatures, i.e. heat, generated by such concentrations is an increasing problem as computer developers pack faster and “hotter” processors into smaller and smaller housings. Air cooling and like environmental equipment have been installed to control the generated heat. However, such equipment comes with its own increased energy consumption. Organizations have been forced to expand their virtual data centers or build new facilities in order to try to deal with heating problems.

### SUMMARY OF THE PRESENT INVENTION

The present invention addresses this problem of thermal load on equipment and its resulting present day increased demand for expanded plant facilities and ancillary cooling equipment and offers a new approach to the thermal load problem that does not require ever expanding facilities and cooling equipment. The present invention recognizes that while the increasing virtualization of data processing systems has created mcre concentrated physical processing environments, it has also resulted in increasing flexibility in data processing distribution. The present invention monitors and tracks the ambient environmental temperature conditions of the facilities, e.g. the plants and offices housing virtual data processing centers and weighs, anticipates and consequently responds to daily, weekly, seasonal and even hourly effects that our changing outside atmosphere has upon the thermal load on the running virtualized data processing systems.

Accordingly, the present invention provides an implementation for thermal load management in a virtualized environment wherein server controlled physical processor systems are partitioned into a plurality of logical partitions (LPAR)s that comprises first predetermining a set of ambient temperature levels for the surrounding outside environment for a first server controlled system having a plurality of LPARs. Then, the set of ambient temperature levels is sensed and if the set or predetermined pattern of temperature levels are exceeded, one or more of the plurality of LPARs are transferred from said first server controlled system to a second server controlled LPAR system over a connecting network.

The invention further involves locating an appropriate second server system for receiving transferred LPARs. Thus, an aspect of the invention includes predetermining a set of ambient temperature levels for the surrounding outside environment for said second server controlled system having a plurality of LPARs, sensing whether the set of ambient temperature levels are exceeded for the second server controlled system and transferring the LPARs only when the set of ambient temperature levels for the second server controlled system are not exceeded.

The invention also enables the return transfer of LPARs from the second server controlled system back to the first server controlled system when temperature levels at the second server controlled system are exceeded while the temperature levels at the first server controlled system are no longer exceeded. The first and second server controlled systems may be at different physical locations in a local area facility and the movement of LPARs back and forth may be on a daily basis as the heat and cooling of the ambient conditions, due to the movement of the sun, progresses.

Likewise, the first and second server controlled systems my be at remote physical locations connected in a global network and the selected periods of time could involve the four seasons.

The invention further provides for heuristically tracking the original transfers and return transfers of the LPARs over selected periods of time to determine patterns of transfers and return transfers and then preemptively making the transfers and returns of the LPARs during the selected periods of time based upon the determined patterns.

Accordingly, a significant aspect of the invention involves thermal load management in a virtualized environment wherein there is heuristically predetermined a time point at which ambient temperature levels for the surrounding outside environment, for a first server controlled system having a plurality of LPARs, are anticipated to cause thermal load problems for the first system. The passage of time for the arrival of said time point is monitored and, responsive to the arrival of this predetermined time point, there is a transfer of at least one of the plurality of LPARs from the first server controlled system to a second server controlled LPAR system over a connecting network. The first and second server controlled systems may be at different physical locations in a local area facility and the movement of LPARs back and forth may be on a time points daily time of day basis as the heat and cooling of the ambient conditions due to the movement of the sun progresses or first and second server controlled systems may be at remote physical locations connected in a global network and the time points would be seasonal.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion that may be used in the practice of the present invention both for illustrative daily transfers of LPARs and illustrative remote global transfers based upon seasonal ambient temperature changes;

FIG. 2 is an illustrative diagrammatic view of a control processor that may be used for the hypervisors of the server systems of FIG. 1;

FIG. 3 is a general flowchart of a program set up to implement the present invention for thermal load management in a virtualized environment by the transfers and returns of the LPARs during the selected periods of time based upon the sensed ambient temperature patterns; and

FIG. 4 is a flowchart of an illustrative LPAR distribution run of the program set up in FIG. 3.

### DETAILED DESCRIPTION OF THE PREFERRED EMBODIMENT

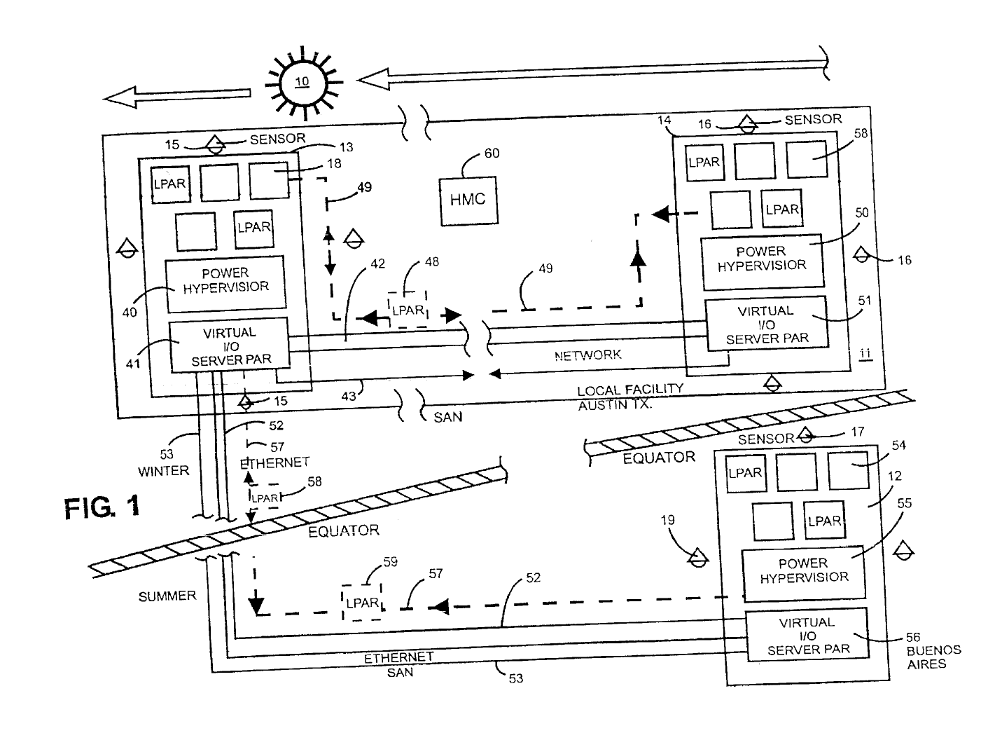

Referring to FIG. 1, there is shown a generalized diagrammatic view of a network portion illustrating the local daily transfers of LPARs based upon local sensed temperature pattern changes and illustrative remote global transfers based upon seasonal ambient temperature changes. With respect to the local facility 11 that may be an office of a business-type facility or the grounds of a communications or data processing service facility for clients, we will consider the distribution of workload in the form of the transfer of Logical Partitions LPARs between an illustrative pair of server controlled partitioned systems: an initial server system 13 and a receiving or destination server system 14. Server systems 13 and 14 may be in different portions of the same building 11 in which the ambient temperatures surrounding server systems 13 and 14 vary considerably with the time of day as illustrated by the path of the sun 10. Alternatively, server system 13 and 14 may respectively be housed at different locations on the ground of a facility site that is subject to different and changing effects as the movement of the sun 10 progresses. Sensors 15 monitor temperature patterns of the ambient environment surrounding initial server system 13 while sensors 16 monitor temperature patterns of the ambient environment surrounding receiving server system 14. A predetermined temperature pattern is developed for sensors 15 that, when reached or exceeded, indicates that a damaging or problem thermal load is imminent for server system 13 unless workload is transferred from the server system. It is not part of, nor essential to, the present invention to use specific temperature patterns. These patterns may be a combination of simultaneous readings of the set of several sensors 15 distributed in the ambient environment surrounding server system 13. These temperature patterns may also include the differential increase/decrease of the set of sensors 15 over a defined time period. These sets of sensed temperature levels may be heuristically developed and predetermined.

Under any predetermined set of surrounding ambient temperature levels when such levels are exceeded there is a transfer of one or more Logical Partitions LPARs from server system 13 to an appropriate receiving or destination server system 14. This transfer must be to a server system 14 that has the capacity to accept the LPARs being transferred and, of course, is so situated within a building or facility grounds 11 that sensors 16 surrounding receiving server system 14 indicate a temperature pattern not exceeding the predetermined temperature pattern for server system 14.

Assuming that the temperature conditions surrounding server system 14 are low enough, there is an LPAR transfer from server system 13 to server system 14 that will be illustrated. A particularly effective form of LPAR mobility has been Live Partition Mobility developed by International Business Machines Corporation (IBM), which is described in the publication, IBM PowerVM Live Partition Mobility, John E. Bailey et al, March 2009, that may be obtained at ibm.com/redbooks, particularly at pp. 1-14. This partition mobility permits the migration or transfer of partitions that are running AIX and Linux operating systems including hosted applications from one physical server system to another without disrupting any infrastructure services. The migration transfers the whole partition system environment including the processor state, memory, attached virtual devices and connected users. A system that has been effectively used for such LPAR transfers is the Power6™ System marketed by IBM.

The respective server operations between server system 13 and server system 14 are respectively controlled by hypervisors 40 and 50 through their respective servers, VIOS partitions 41 and 51, i.e. each of the initial 13 and destination 14 systems is respectively configured with a single Virtual I/O Server partition 41 and 51. The transfer of mobile partition 4E, as illustrated along a path 49 from system 13 to system 14 over an Ethernet 42 such as the Internet, uses iSCSI protocols. Both initial system 13 and destination system 14 also access, through their respective virtual server partitions 41 and 51 in support of the transfer, an external storage system: the storage area network (SAN) 43 that is supported by a storage system. The transferred LPAR 48 is selected by hypervisor 40 from the plurality of LPARs 18 supported by server system 13 dependent upon workload distribution requirements. At the local facility 11, such as a data center, the distribution of LPARs back and forth between server systems 13 and 14, as will be described further, may be coordinated by the data center's Hardware Management Console (HMC) 60.

As the day progresses, e.g. overnight, the ambient temperature pattern surrounding server system 14 may reach a level that exceeds the predetermined level of the pattern of sensors 16 and there will be a need to transfer one or more of the LPARs 58 supported by system 14. At such a point, there will be a reverse transfer of one or more LPARs 48 back to initial system 13 along path 49. Of course, in each such transfer back and forth there must be an initial determination made that the destination server has the capacity to accept such transferred LPARs.

This embodiment has just used a pair of server systems 13 and 14 for simplicity of illustration. It will be understood that the local facility 11, e.g. data center, may have several server systems located through the facility area. LPARs may be distributed and redistributed as described between more than just a pair of server systems.

It will be further understood that the tracked temperature patterns at the respective servers will be saved and heuristically analyzed, conveniently at the HMC 60, to the point that times when the predetermined temperature patterns at specific server systems may be anticipated and LPARs may be preemptively moved and returned based upon the progress of time at anticipated time points of the day, month or seasons.

There is further illustrated in FIG. 1, transfer of LPARs in accordance with the present invention between remote, e.g. global, locations dependent upon respective temperature pattern sensing and/or anticipated temperature patterns. For the illustration, the selected location are Austin and Buenos Aires on opposite sides of the EQUATOR. Thus, temperatures will be opposite: winter-like vs. summer-like. The illustrative single server system 12 in Buenos Aires has elements equivalent to those in initial server system 13: a plurality of LPARs 54, hypervisor 55 and virtual I/O server partition 56. The temperature pattern is sensed by a set of sensors 17. Thus, as sensed temperature patterns are exceeded or the exceeding of such temperature patterns is anticipated between the Austin and Buenos Aires server systems, illustrated LPARs 59 may be transferred back and forth along illustrated path 57 across the EQUATOR via an Ethernet 52, such as the Internet using iSCSI protocols. Both initial system 13 and destination system 12 access, through their respective virtual server partitions 41 and 56, an external storage system: the storage area network (SAN) 53 that is supported by a storage system.

While the transfer of LPARs between remote locations has been illustrated between server system locations with substantial seasonal ambient temperature differences, such transfers and returns of LPARs in accordance with the present invention may be made on a daily or hourly basis just between locations in different time zones, e.g. Austin, Texas, and London.

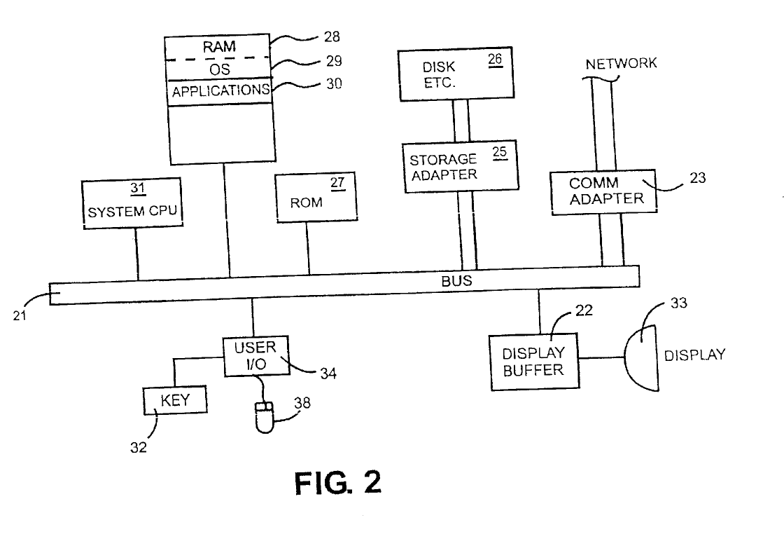

With respect to FIG. 2, there is shown an illustrative diagrammatic view of a control processor that may be used for power hypervisors 12, 13 and 14 or for HMC 60 of FIG. 1. A central processing unit (CPU) 31, such as one of the microprocessors or workstations, e.g. System p™ series, eServerp5, eServer OpenPower™ or the PowerVM Standard edition, available from IBM, is provided and interconnected to various other components by system bus 21. An operating system (OS) 29 (e.g. a Linux System) runs on CPU 31, provides control and is used to coordinate the function of the various components of FIG. 2. Operating system 29 may be one of the commercially available operating systems. Application programs 30, controlled by the system, are moved into and cut of the main memory Random Access Memory (RAM) 28. These programming applications may be used to implement functions of the present invention. ROM 27 includes the Basic Input/Output System (BIOS) that controls the basic computer functions of the hypervisor or HMC. RAM 28, storage adapter 25 and communications adapter 23 are also interconnected to system bus 21. Storage adapter 25 communicates with the disk storage device 26 of the server system. Communications adapter 23 interconnects bus 21 with the ethernet network. I/O devices are also connected to system bus 21 via user interface adapter 34. Keyboard 32 and mouse 38, when appropriate, may be connected to bus 21 through user interface adapter 34. Display buffer 22 supports an appropriate display 33.

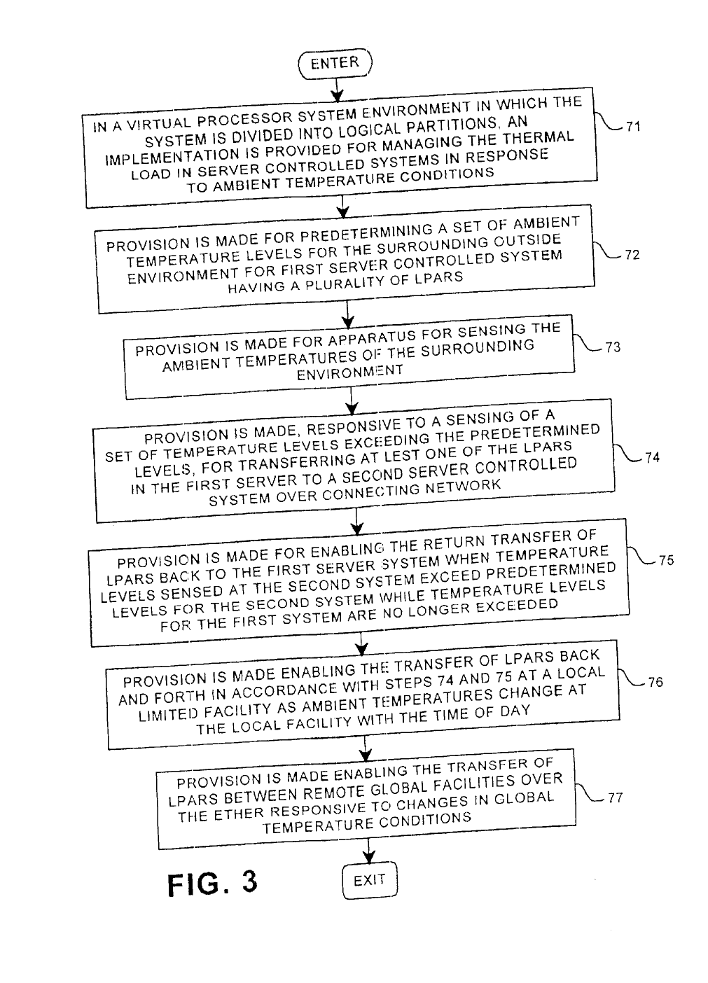

FIG. 3 is a general flowchart of a program set up to implement the present invention for management of the thermal load in a virtual processor environment in which the system is divided into logical partitions. An implementation is provided for managing the thermal load in server controlled systems in response to sensed ambient temperature conditions, step 71. Provision is made for predetermining a set of sensed ambient temperature levels for the outside environment surrounding a first server controlled system having a plurality of LPARs, step 72. Apparatus is provided for sensing the ambient temperatures of the surrounding environment, step 73. Provision is made, responsive to a sensing that a set of temperature levels exceed the predetermined levels, for transferring at least one of the LPARs in the first server system to the second server controlled system over a connecting network, step 74. Provision is made for enabling the return transfer of LPARs back to the first server system when temperature levels sensed at the second system exceed predetermined levels for the second system while the set of temperature levels at the first server controlled system are no longer exceeding, step 75. Further, provision is made for enabling the transfer of LPARs back and forth in accordance with steps 74 and 75 at a local limited facility as ambient temperatures change at the local facility with the time of day, step 76. Provision is also made for the transfer of LPARs between remote global facilities over the ethernet responsive to changes in global temperatures, step 79.

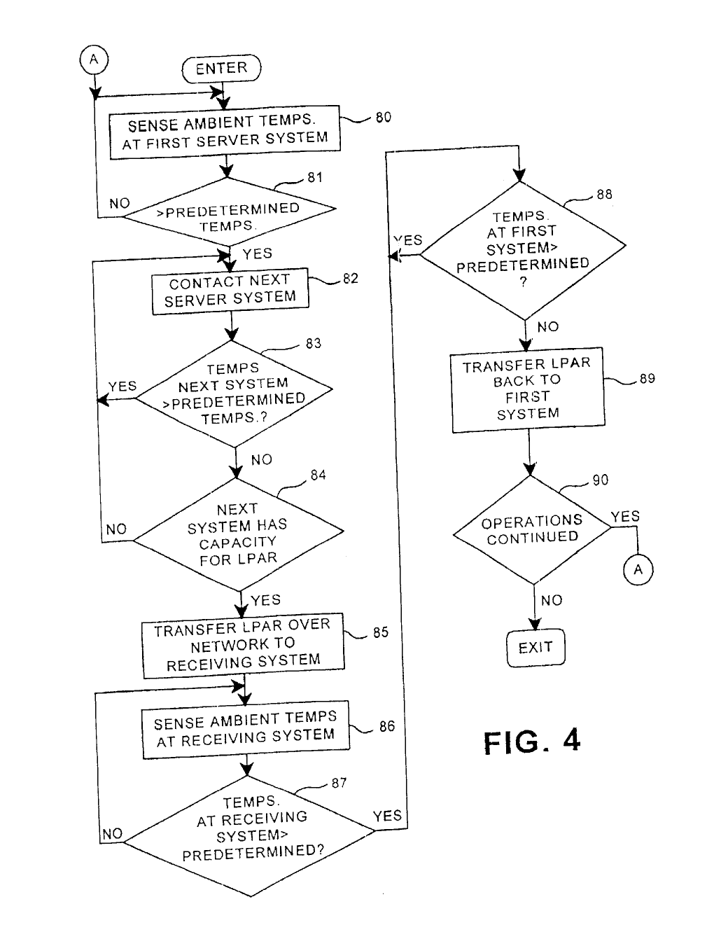

A simple illustrative example of a run of the process set up in FIG. 3 will be described with respect to the flowchart of FIG. 4. As the virtualized server controlled partitioned systems at a facility are being run, the ambient temperatures surrounding a first server system are being sensed in accordance with the present invention, step 80. The temperatures are continuously sensed and a determination made as to whether the predetermined levels for the surrounding temperatures are exceeded, step 81. If Yes, then a next network connected server system is contacted, step 82, and a determination is made, step 83, as to whether the sensed temperatures surrounding the next system exceed the predetermined levels for the next system. If Yes, then the process is returned to step 82 wherein a further determination is again made, step 83, as to whether the sensed temperatures surrounding a further next system exceeds the predetermined levels for the further next system. If the step 83 decision is No, then a further determination is made as to whether the selected next server system has capacity to support LPARs to be transferred, step 84. If No, then the process is again returned to step 82 wherein the above-described process is continued. However, if the determination in step 84 is Yes, capacity exists, then, step 85, the LPAR or LPARs are transferred over the connecting network to the second or receiving system.

Now, with respect to a potential return transfer as sensed temperature patterns change, the temperatures at the receiving system are continuously sensed, step 86, and a determination is made, step 87, as to whether the predetermined levels for the surrounding temperatures for the receiving system are exceeded. If Yes, then the originating first server system is contacted and a determination is made, step 88, as to whether the sensed temperatures surrounding the first system exceed the predetermined levels for the first system. If No, then LPARs are transferred back to the first server controlled system, step 89. As described hereinabove, this transferring back and forth with changing ambient temperature patterns may be continuous. Periodically, a determination may be made as to whether the operations of the facility data center are still continuing, step 90. If No, the process is exited. If Yes, the process is returned to step 80 via branch “A” and continued as described hereinabove.

Although certain preferred embodiments have been shown and described, it will be understood that many changes and modifications may be made therein without departing from the scope and intent of the appended claims.

What is claimed is:

1. A methcd for thermal load management in a virtualized environment wherein server controlled physical processor systems are partitioned into a plurality of logical partitions LPARs comprising:
predetermining a set of ambient temperature levels for the surrounding outside environment for a first server controlled system having a plurality of LPARs;
sensing whether said set of ambient temperature levels are exceeded; and
responsive to a sensing that said set of temperature levels are exceeded, transferring at least one of said plurality of LPARs from said first server controlled system to a second server controlled LPAR system over a connecting network.

2. The method of claim 1 further including:
predetermining a set of ambient temperature levels for the surrounding outside environment for said second server controlled system having a plurality of LPARs;
sensing whether said set of ambient temperature levels are exceeded for said second server controlled system; and
transferring said LPAR only when said set of ambient temperature levels for said second server controlled system are not exceeded.

3. The method of claim 2 further including enabling the return transfer of LPARs from said second server controlled system back to said first server controlled system when temperature levels at said second server controlled system are exceeded while the temperature levels at said first server controlled system are not exceeded.

4. The method of claim 3 wherein said first and second server controlled systems are at different physical locations in local area facility.

5. The method of claim 3 further including:
heuristically tracking said transfers and return transfers of said LPARs over selected periods of time to determine patterns of said transfers and return transfers; and
preemptively making said transfers and returns of said LPARs during said selected periods of time based upon said determined patterns.

6. The method of claim 2 wherein said first and second server controlled systems are at remote physical locations connected in a global network.

7. The method of claim 5 wherein:
said first and second server controlled systems are at remote physical locations connected in a global network; and
said selected periods of time are the four seasons.

8. A computer controlled system for thermal load management in a virtualized environment wherein server controlled physical processor systems are partitioned into a plurality of logical partitions LPARs, comprising:
a processor; and
a computer memory holding computer program instructions that, when executed by the processor, perform the method comprising:
predetermining a set of ambient temperature levels for the surrounding outside environment for a first server controlled system having a plurality of LPARs;
sensing whether said set of ambient temperature levels are exceeded; and
responsive to a sensing that said set of temperature levels are exceeded, transferring at least one of said plurality of LPARs from said first server controlled system to a second server controlled LPAR system over a connecting network.

9. The system of claim 8 wherein the performed method further includes:
predetermining a set of ambient temperature levels for the surrounding outside environment for said second server controlled system having a plurality of LPARs;
sensing whether said set of ambient temperature levels are exceeded for said second server controlled system; and
transferring said LPAR only when said set of ambient temperature levels for said second server controlled system are not exceeded.

10. The system of claim 9 wherein the performed method further includes enabling the return transfer of LPARs from said second server controlled system back to said first server controlled system when temperature levels at said second server controlled system are exceeded while the temperature levels at said first server controlled system are not exceeded.

11. The system of claim 10 wherein said first and second server controlled systems are at different physical locations in a local area facility.

12. The system of claim 10 wherein the performed method further includes:
heuristically tracking said transfers and return transfers of said LPARs over selected periods of time to determine patterns of said transfers and return transfers; and
preemptively making said transfers and returns of said LPARs during said selected periods of time based upon said determined patterns.

13. The system of claim 9 wherein said first and second server controlled systems are at remote physical locations connected in a global network.

14. The system of claim 12 wherein:
said first and second server controlled systems are at remote physical locations connected in a global network; and
said selected periods of time are the four seasons.

15. A computer usable storage medium having stored thereon a computer readable program for thermal load management in a virtualized environment wherein server controlled physical processor systems are partitioned into a plurality of logical partitions LPARs, wherein the computer readable program when executed on a computer causes the computer to:
predetermine a set of ambient temperature levels for the surrounding outside environment for a first server controlled system having a plurality of LPARs;
sense whether said set of ambient temperature levels are exceeded; and
responsive to a sensing that said set of temperature levels are exceeded, transfer at least one of said plurality of LPARs from said first server controlled system to a second server controlled LPAR system over a connecting network.

16. The computer usable medium of claim 15 wherein the computer program when executed further causes the computer to:
predetermine a set of ambient temperature levels for the surrounding outside environment for said second server controlled system having a plurality of LPARs;
sense whether said set of ambient temperature levels are exceeded for said second server controlled system; and
transfer said LPAR only when said set of ambient temperature levels for said second server controlled system are not exceeded.

17. The computer usable medium of claim 16 wherein the computer program when executed further causes the computer to enable the return transfer of LPARs from said second server controlled system back to said first server controlled system when temperature levels at said second server controlled system are exceeded while the temperature levels at said first server controlled system are not exceeded.

18. The computer usable medium of claim 17 wherein said first and second server controlled systems are at different physical locations in a local area facility.

19. The computer usable medium of claim 17 wherein the computer program when executed further causes the computer to:
heuristically track said transfers and return transfers of said LPARs over selected periods of time to determine patterns of said transfers and return transfers; and
preemptively make said transfers and returns of said LPARs during said selected periods of time based upon said determined patterns.

20. The computer usable medium of claim 16 wherein said first and second server controlled systems are at remote physical locations connected in a global network.

21. A method for thermal load management in a virtualized environment wherein server controlled physical processor systems are partitioned into a plurality of logical partitions LPARs comprising:
heuristically predetermining a time point at which ambient temperature levels for the surrounding outside environment for a first server controlled system having a plurality of LPARs are anticipated to cause thermal load problems for said first system;
montoring the passage of time for the arrival of said time point; and
responsive to the arrival of said predetermined time point, transferring at least one of said plurality of LPARs from said first server controlled system to a second server controlled LPAR system over a connecting network.

22. The method of claim 21 wherein:
said first and second server controlled systems are at different physical locations in local area facility; and
said predetermined time point is hourly.

23. The method of claim 21 wherein:
said first and second server controlled systems are at remote physical locations connected in a global network; and
said time points are seasonal.

24. A computer usable storage medium having stored thereon a computer readable program for thermal load management in a virtualized environment wherein server controlled physical processor systems are partitioned into a plurality of logical partitions LPARs, wherein the computer readable program when executed on a computer causes the computer to:
heuristically predetermine a time point at which ambient temperature levels for the surrounding outside environment for a first server controlled system having a plurality of LPARs are anticipated to cause thermal load problems for said first system;
monitor the passage of time for the arrival of said time point; and
responsive to the arrival of said predetermined time point, transfer at least one of said plurality of LPARs from said first server controlled system to a second server controlled LPAR system over a connecting network.

25. The computer usable storage medium of claim 24 wherein:
said first and second server controlled systems are at different physical locations in a local area facility; and
said predetermined time point is hourly.

26. The computer usable storage medium of claim 24 wherein:
said first and second server controlled systems are at different, physical locations in a local area facility; and
said predetermined time point is hourly.
